(19) United States
(12) Patent Application Publication
(10) Pub. No.: US 2005/0125291 A1
(43) Pub. Date: Jun. 9, 2005

(54) Systems and methods of managing marketing campaigns

(76) Inventors: Timothy Ray Demkiw Grayson, Ottawa (CA); Warren Lloyd Tomlin, Carlston Place (CA)

Correspondence Address: SMART & BIGGAR/FETHERSTONHAUGH & CO.;P.O. BOX 2999, STATION D, 900-55 METCALFE STREET, OTTAWA, ON, K1P5Y6, CA

(21) Appl. No.: 10/986,800

(22) Filed: Nov. 15, 2004

Related U.S. Application Data
(60) Provisional application No. 60/519,613, filed on Nov. 14, 2003.

(51) Int. Cl. G06F 17/60

(52) U.S. Cl. 705/14

(57) ABSTRACT

Systems and methods relating to management of marketing campaigns are provided. Requests from users are matched to stored offers relating to available marketing materials to generate an order for each request. Orders may be fulfilled by delivering the marketing materials to the user, for example. The matching of requests to offers may be based on information in the requests, user information associated with users from which the requests are received, offer rules associated with the stored offers, or any combination thereof. Some embodiments provide for user registration with a marketing campaign management system which exploits user information which is available from an external source, such as a service provider system which provides a service for which the user has previously registered or a system which provides a reverse lookup function.

### CROSS-REFERENCE TO RELATED APPLICATIONS

This application claims the benefit of U.S. Provisional Patent Application No. 60/519,613 entitled “System And Method Of Managing Marketing Communications”, filed on Nov. 14, 2003.

The present application is also related to U.S. patent applications Ser. Nos. [Attorney Docket No. 72750-1059] entitled “System And Method For Coordination Of Delivery Of Advertising Material”, and Ser. No. [Attorney Docket No. 72750-1066] entitled “Systems And Methods Of Providing Marketing Campaign Management Services”, both commonly owned with the present application and filed of even date herewith.

The entire contents of each of these related applications is incorporated by reference herein.

### FIELD OF THE INVENTION

This invention relates generally to marketing and, in particular, to managing marketing materials and campaigns.

### BACKGROUND

Marketing activities such as advertising are of primary importance for distribution of product- and service-related communications to consumers. These communications range from information on the products and services themselves to product samples and service trial periods, for example. Achieving greater effectiveness from the significant costs of these activities is a vital challenge to marketers in their efforts to promote their goods or services in the marketplace, to acquire new customers, to build loyalty by retaining existing customers and fostering positive customer relationships, and to increase sales. Marketers generally prefer to build one-to-one relationships with customers to get the right information, and eventually products or services, into the right hands at the right time.

Marketers deliver information to their customers through a variety of media. Television and daily newspapers are currently two of the most popular advertising media. However, while these large, traditional media have historically captured a major proportion of advertising expenditures, newer media such as the Internet are rapidly increasing in popularity. Other alternative advertising and marketing approaches, including relationship marketing such as through sponsoring and partnering, telemarketing, and direct mailing, for example, are also used by marketers to enhance the reach of their campaigns.

Each advertising medium has its own benefits and drawbacks. For example, a pet food manufacturer may wish to identify and build a close relationship with dog owners in order to provide each owner with information on an appropriate dog food formula as a dog ages. While this marketer uses media that are expected to reach the targeted segments of the population, namely dog owners, most effectively, an advertising broadcast often reaches other segments of the population that may have no need for or interest in pet foods. As such, the advertising message “slips” toward many uninterested consumers.

The volume of undesired advertising that reaches a hostile audience is epic, and is unintentionally resulting in a consumer backlash against advertising. Features and services that let the consumer filter out advertising or receive only the messages they want are gaining a broad acceptance. For example, many email programs provide filters that identify and either delete or divert received unsolicited “spam” or “junk” email messages from a user's email Inbox. Software that allows users to block pop-up and pop-under ads are also becoming more common.

To an increasingly demanding and sophisticated consumer, the means by which marketers can currently get their messages out are rapidly being rendered ineffective. Thus, they fall short of what marketers hope to achieve. The consumer wants control over what he or she receives, while the marketer needs to get a message to both desiring and merely desirable target consumers or identified prospects. The message must also be specifically and generally meaningful: a troubling paradox.

One significant shortcoming of known advertising techniques is the lack of media interactivity. Media are used in a somewhat coordinated but disjointed way. They remain distinct and separate channels with limited interaction. This is inherently inadequate, as the marketer cannot fully coordinate a strategic program maximizing the full breadth of its targets' media utilization.

Conventional advertising is also prone to information latency and delayed feedback. Marketing communications typically involve a rapid one-way message by the marketer with a potential for indirect, slow, and often inferred response from the user. Information latency due to this slow and cumbersome feedback loop results in sub-optimal effectiveness measurement alternatives. The opportunity for real-time campaign refinement is all but non-existent.

Many advertising media, excepting point-of-purchase and some specialty media, do not lend themselves to consumer impulsiveness. Making a marketing communication meaningful to a customer at a time when he or she can act immediately or impulsively may be valuable to marketers.

Marketers use and gauge success of media and campaigns by measuring returns on investment, normally using benchmarks for reach, acquisition cost, retention cost, etc. Collection of these types of information for advertising tends to be expensive and not very timely. The immediacy, accuracy, and relevancy values for these measures are high for aggregated-campaign-level metrics, but lower for addressing specific key factors and causalities. Lower cost, more timely measures of market response may be more valuable for tactical decision-making.

On the consumer side, consumers often want broader access to information, more focused and timely messages, and more control over the information received. As noted above, much advertising is increasingly provoking negative consumer reaction from frustration and annoyance with unwanted and in some cases invasive advertising. Consumer negative reaction to advertising may be due, at least in part, to a failure of conventional advertising schemes to satisfy evolving consumer needs.

For example, a consumer usually has limited options for dealing with interesting advertising messages in a meaningful and timely way due to the nature of most marketing communications. Often, the burden is on the consumer to remember the message and address it later when they have the means to do so. However, the relevance of the advertising diminishes over time, as does the satisfaction with a product when the process for obtaining information and ultimately purchasing it becomes burdensome.

Even consumers that are gathering information may wish to remain anonymous until they choose to engage the marketer in order to avoid receiving unwanted materials through direct marketing campaigns, for example. Obtaining material from a marketer by mail or via an email request creates an address bridge that often allows further unsolicited communication. Many consumers avoid interaction where they cannot control the consent to communicate. As mentioned briefly above, a consumer is often unable to easily and quickly respond to an ad in a convenient and desirable way.

Limited delivery and response options further degrade advertising effectiveness. Marketers typically broadcast messages to the consumer, and the options for responding in a way valuable either to the consumer or to the marketer are severely limited. Even where multiple delivery options for subsequent marketing communications such as brochures and free samples are provided, known mechanisms for user selection of a delivery option tends to be cumbersome.

### SUMMARY OF THE INVENTION

According to one aspect of the invention, a method of managing a marketing campaign is provided. The method includes operations of configuring a marketing campaign management system to store an offer of marketing materials which are to be made available through the marketing campaign management system, receiving at the marketing campaign management system a request from a user relating to the offer, processing the request based on at least the offer and user information for the user stored at the marketing campaign management system, and generating an order comprising at least a portion of the user information and offer information associated with the offer to which the request relates.

A request relating to the offer which is received from a user for which user information has not been stored at the marketing campaign management system may be processed based on the offer and at least one of information in the further request and additional user information subsequently received from the user.

A marketing campaign management system in accordance with another aspect of the invention includes an offers store for storing offer information associated with offers corresponding to respective marketing materials available through the management system, a user information store configured to store user information corresponding to users of the management system, an administration interface for providing access to the offers store to configure offers in the offers store, and a request system. The request system is adapted to receive from a user a request relating to any one of the offers, to process the request based on at least offer information associated with the one of the offers and user information for the user, and to generate an order comprising at least a portion of the user information and the offer information for the one of the offers.

Either or both of the administration interface and the request system may be implemented in a processor.

The administration interface, the request system, or other components of the management system may be configured to perform additional functions, including those described above.

A method of processing a service request associated with a service provided by a first service provider system is also provided. The request processing method includes operations of receiving, at the first service provider system, a service request from a user, the service request being associated with the service, determining whether user information for the user is available to the first service provider system from a source external to the first service provider system, obtaining the user information from the external source where user information for the user is available to the first service provider system from a source external to the first service provider system, and processing the service request based on at least a portion of the user information obtained from the external source. The external source may be, for example, a second service provider system with which the user has registered for a second service or a system providing a reverse lookup function.

According to yet another aspect of the invention, there is provided a method of managing access codes associated with a marketing campaign management system. The system stores in an offers store offers associated with at least one marketing campaign and processes user requests relating to the offers. The method includes operations of configuring the offers store to store multiple access codes for one of the stored offers, receiving, at the marketing campaign management system, a request from a user, the request including any one of the access codes, processing the request to match the request with the one of the stored offers based on the one of the access codes, and storing request processing information comprising information associated with the one of the offers and information associated with the one of the access codes.

The access codes may be respectively associated with user communication channels via which requests may be received or advertising media through which the access codes are disseminated.

Other aspects and features of the present invention will become apparent to those of ordinary skill in the art, upon review of the following description of the specific embodiments of the invention.

### BRIEF DESCRIPTION OF THE DRAWINGS

The invention will now be described in greater detail with reference to the accompanying diagrams, in which:

FIG. 1 is a block diagram of a system in which marketing campaign management according to an embodiment of the invention is implemented;

FIG. 2 is a block diagram showing a detailed representation of a marketing campaign management system;

FIG. 3 is a block diagram showing an embodiment of the translator 32 of FIG. 2;

FIG. 4 is a flow diagram showing a method of processing a user request in accordance with an embodiment of the invention;

FIG. 5 is a flow chart of an example business method according to an aspect of the invention;

FIG. 6 is an example data structure for user information; and

FIG. 7 is an example data structure for offer information.

### DETAILED DESCRIPTION OF PREFERRED EMBODIMENTS

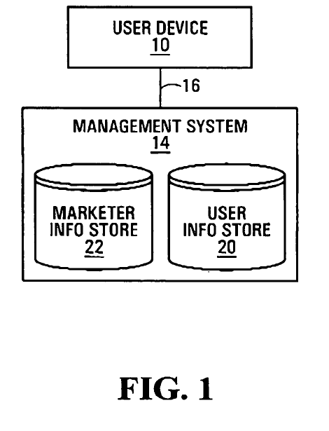

FIG. 1 is a block diagram of a system in which marketing campaign management according to an embodiment of the invention is implemented. The system of FIG. 1 includes a consumer user device 10 and a management system 14, and represents a simple overview of a marketing campaign management system. Many implementations will include further components than those specifically shown in FIG. 1.

Using the user device 10, which generally represents a communication device, a potential purchaser or consumer of products or services of a marketer which operates the management system 14 communicates with the management system 14 over a communication channel 16. As described in further detail below, the communication channel 16 may be any of a plurality of different types of communication channel. The user may register with the management system 14 by providing registration information, such as name and address information, to the management system 14 for storage in a user information store 20, which may be implemented using virtually any storage device, including a solid state memory device, a disk drive, or even a combination of different types of memory device, for example. It should also be appreciated that user registration need not necessarily be required. Several mechanisms for handling non-registered users are also described in further detail below.

The management system 14 is configured or administered by a marketer as described in further detail below. The marketer may administer the management system 14 through the same or a different type of communication channel than the communication channel 16. One or more marketing campaigns are configured in the management system 14 and subsequently administered by the marketer by storing marketer information in the marketer information store 22. Marketer information preferably includes information regarding marketing campaign materials that the marketer wishes to make available to users of the management system 14. After the marketer has configured a campaign with the management system 14, users are informed of the registration in subsequent advertising by the marketer.

Although shown in FIG. 1 as a single store 22, some embodiments of the invention utilize multiple stores for marketer information. For example, a marketer might establish an account for a particular campaign or brand in a marketer registry which stores information about the campaign and authorization information for account management, as well as one or more offers in an offer registry. In one embodiment, the marketer creates a single master account and a subordinate account for each of its brands, products, or services. Offers in the offer registry may then be associated with and managed in conjunction with particular subordinate accounts. Management systems which provide marketing campaign management services for “external” marketers, in which a marketer does not own or operate a management system for its own campaigns, are also contemplated. The co-pending and commonly assigned U.S. patent application Ser. No. [Attorney Docket No. 72750-1066], referenced above, relates to such marketer-specific management systems.

At the management system 14, user information and marketer information are securely stored in the stores 20 and 22 and protected from external access from outside the management system 14. Only the management system 14 has access to both the user information and the marketer information, although in some embodiments a user is allowed to access his or her own user information in the user information store 20.

In one embodiment, different data stores are provided for personal and non-personal user information. For example, personal information such as first name, middle name or initial, last name, a user name or other user identifier, a password, and a password challenge question and answer may be stored in one data store, illustratively a data store which is accessible using Lightweight Directory Access Protocol (LDAP). A separate second data store, illustratively in a different storage device, may be provided for non-personal information such as a mailing address and an email address to be used in fulfilling user requests for marketing materials. Such a separate storage scheme may be desirable where personal and non-personal information are used for different purposes or require different levels of security.

In operation, after the marketer has configured at least one marketing campaign or offer with the management system 14, the management system 14 processes requests from the user device 10. A user of the device 10, who may or may not have registered with the management system 14, may submit a request after viewing a television ad from the marketer, for instance. When a request is received, the management system 14 attempts to identify the user from which the request was received, accesses the user information store 20, if the user is a registered user, and the marketer information store 22, and determines any action to be taken in response to the request. For example, where the marketer has configured offers for a free information package and a free product sample with the management system 14, the management system 14 determines any marketing campaign materials (i.e., the information, the sample, or both) to which the received request relates. The requested marketing campaign materials are then sent to the user. The management system 14 determines where and how to send the marketing campaign materials to the user based on available delivery options established by the marketer, information in the user information store 20 if the user is a registered user, and possibly a user selection of a delivery option in the request.

In the case of a non-registered user, the management system 14 may determine information about the user from the request itself. For example, a telephone number may be available from a request which is made by a landline telephone or a mobile telephone. Similarly, an email address could be determined from an email request. Further information may be available for a non-registered user from a reverse lookup or from other service providers, for instance. If all user information which is required by the management system 14 for fulfillment of a user request cannot be determined from the request itself, then the user may be prompted to provide further information. Any further information received from the user may be stored in the user information store 20 to effectively register the user with the management system 14, or stored only temporarily until the request has been fulfilled. Request handling, including processing of requests from non-registered users, is described in further detail below.

Thus, the system of FIG. 1 provides an alternative to conventional advertising and marketing techniques for both marketers and consumers. Through the management system 14, existing advertising media are made more interactive and effective. Although the user may potentially provide information to the management system 14, only requested marketing campaign materials are received from the marketer. In addition, the marketer benefits by being able to target marketing materials to users that have demonstrated an interest by submitting requests.

It should be appreciated that references to “marketing campaigns”, “marketing materials”, “marketing communications”, and the like, are intended to denote a broad range of materials or services that may be managed in accordance with aspects of the invention. In some embodiments, a marketing campaign may include offers of produce samples, coupons, brochures, product or service information, forms, and the like. In other embodiments, marketing campaigns may involve a follow-up telephone call or connection to a call center in response to a user request. Marketing communications associated with a marketing campaign offer may also report to a user the result or progress of a service that is managed by the management system 14 on behalf of the marketer, such as entry into a contest, casting a vote, or purchase of a product or service associated with a marketer, for instance. Other forms of marketing campaign-related communications and materials will be apparent to those skilled in the art.

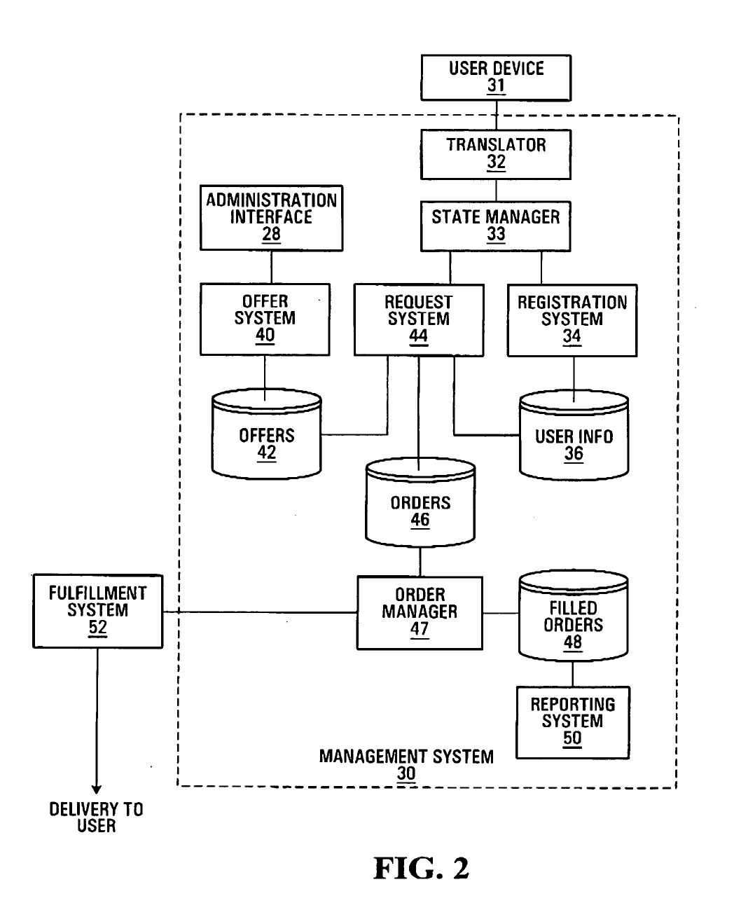

FIG. 2 is a block diagram showing a detailed representation of a marketing campaign management system. The management system 30 communicates with a user of the user device 31, a marketer through the administration interface 28, and a fulfillment system 52, and includes a translator 32 connected through a state manager 33 to a registration system 34 and a request system 44, an offer system 40 connected to the administration interface 28 and an offers store 42, a user information store 36 connected to the registration system 34 and the request system 44, and an orders store 46 connected to the request system 44 and an order manager 47. The order manager 47 communicates with the fulfillment system 52 and is connected to a filled orders store 48, which is connected to a reporting system 50. As shown, the request system 44 is also connected to the offers store 42.

Those skilled in the art will appreciate that the system shown in FIG. 2 is presented solely for illustrative purposes, and that the invention is in no way limited thereto. The management techniques disclosed herein may be implemented differently than shown in FIG. 2 without departing from the scope of the invention.

Although only a single user device is shown at 31, it should be appreciated that a user may communicate with the management system 30 through any of a plurality of channels or interfaces. For example, the user may communicate with the management system 30 using a computer system, such as through a web browser and the Internet. Telephone networks support other user channels through which the user may communicate with the management system 30, including a call centre, an automated telephone system, and a voice recognition system for instance. Wireless communication devices and networks provide for such further user channels as Short Message Service (SMS), Multimedia Message Service (MMS), and Wireless Application Protocol (WAP). Therefore, the user may communicate with the management system 30 using any of a number of different types of devices, including computer systems, telephones, and wireless communication devices, for example, and each device may itself support different user channels.

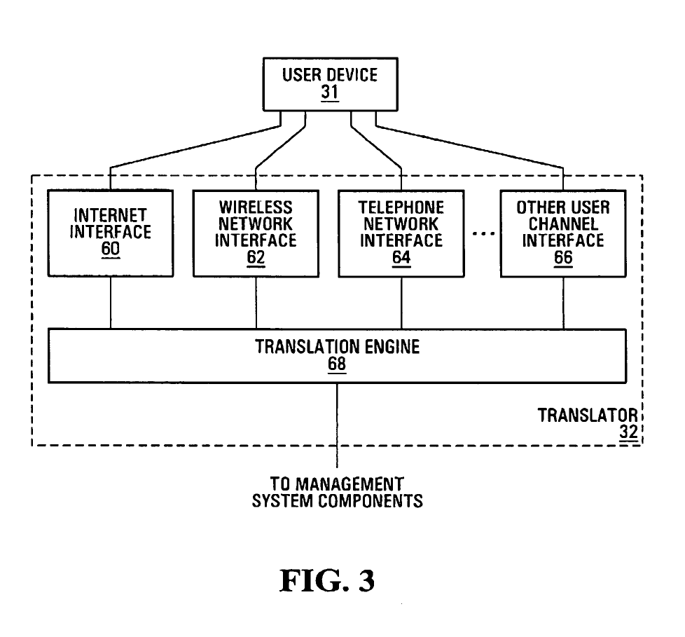

The translator 32 translates information between user channel formats or protocols and an internal protocol used within the management system 30. Communications between the user device 31 and the management system 30 will likely most often be “incoming” to the management system 30 from the user device 31. However, the translator 32 is preferably configured to translate communications in either direction, from the user device 31 to the management system 30 and from the management system 30 to the user device 31. An example implementation of the translator 32 is described in further detail below with reference to FIG. 3.

As described briefly above and in further detail below, user registration and requests may involve multiple exchanges of information between the management system 30 and the user device 31, where the management system 30 prompts the user for information which is required to process a request, for instance. The state manager 33 is operative to maintain a state of a communication or processing session between the management system 30 and the user device 31 in these circumstances.

This effectively allows the management system 30 to “incrementally” process communications from the user device 31 without losing a previous context. If the user initially provides only an email address during registration and registration with the management system 30 also requires a user mailing address, for example, then the state manager 33 maintains the state of the session between the management system 30 and the user device 31, illustratively by storing state information in a data sore, when a mailing address is requested from the user. When the mailing address is received from the user device 31, the management system 30 may then resume registration processing for the user instead of re-starting the entire registration process. State management may be particularly useful for a user channel such as SMS, in which a current information transfer is not normally associated with any previous transfers.

The state manager 33 may maintain the state of a session for a particular user or user device 31 for a predetermined number of exchanges with the management system 30 or for a predetermined time period, to ensure that states are not maintained indefinitely. If a processing function is not completed after the number of exchanges or within the time period, then the function may be restarted. Other error processing operations may also or instead be performed in the event that a processing function is not properly completed.

In the system of FIG. 2, the marketer communicates with the offer system 40 using a the administration interface 28, which may be a predetermined channel or type of interface. However, it should be appreciated that different channels may be supported for the administration interface 28, substantially as described above for the user device 31. In such embodiments of the invention, multiple marketer channels are supported by connecting the administration interface 28 and the offer system 40 to either the translator 32 or to a separate translator. State management, described above for an interface to the user device 31, may similarly be provided for the administration interface 28.

It should be appreciated that the administration interface 28 is intended to represent an “internal” interface in the sense that a marketer, as an owner and/or operator of the management system 30, may configure marketing campaigns and offers. The management system 30 is thus preferably a closed system which is used to manage marketing campaigns for a single entity, as opposed to the marketing campaign management services described in the co-pending application [Attorney Docket No. 72750-1066] referenced above.

The registration system 34 receives user registration information and populates the user information store 36. The user information store 36 is analogous to the user information store 20 of FIG. 1. Using the administration interface 28, a marketer enters information into the offer system 40 to populate the offers store 42, which is analogous to the marketer information store 22. As described above, some embodiments of the invention include multiple stores associated with the marketer, such as a store for marketer account information, although only the offers store 42 is shown in FIG. 2. The user information store 36 may also include multiple data stores or even separate memory devices to separate personal and non-personal user information.

The request system 44 uses both user information and information in the offers store 42 to generate orders responsive to user requests relating to marketing campaign offers which have been configured by a marketer through the administration interface 28. If a registered user submits a request, then the request system 44 may retrieve the user information from the user information store 36. For non-registered users, the request system 44 may receive the user information in a user request, determine the user information based on a user request, and/or prompt a user to provide the user information or portions thereof. Therefore, the request system 44 might not access user information in the user information store 36 in all embodiments of the invention.

Orders are preferably stored in the orders store 46 until they are forwarded to the fulfillment system 52 by the order manager 47. Fulfillment includes any physical and/or electronic logistical activities involved in fulfilling orders for offers that a user has requested. Orders that have been fulfilled are then transferred to the filled orders store 48 by the order manager 47, and used by the reporting system 50 to generate reports for users, marketers, or both.

Each of the stores 36, 42, 46, and 48 preferably includes a database, such as an Oracle™ database, in which records are stored in respective predetermined and preferably searchable formats. Alternative data store types and access mechanisms may also be used, including an LDAP store for storing users' personal information as described above. In some embodiments, combinations of different data store types are used, with an LDAP store for users' personal information and Oracle databases for users' non-personal information and marketer, offer, and order information.

Since user information, offers and orders include different types of information, the stores 36 and 42 will likely have different data storage formats in most embodiments of the invention. A further “offers” data format may be common to the stores 46 and 48. It should be appreciated, however, that a general data format that is common across all of the stores 36, 42, 46, and 48 is also contemplated. In one example embodiment, such a general data format is defined with a plurality of data fields to accommodate all types of data that may be encountered in user information, offer information, and orders. Data fields are then populated or unused as appropriate for the type of information being stored.

In one possible implementation, the management system 30 communicates with many user devices 31. As described briefly above, each user may register with or submit requests to the management system 30 through a user channel, a website or call centre for example. During user registration, if a user chooses to register with the management system 30 or the management system 30 is configured to service only registered users, a user provides user registration information such as name, address, telephone number, email address, etc. The translator 32 translates information from the user channel currently being used by the user into a format that can be used by at least the registration system 34, and preferably any of the other components of the management system 30. The translated user registration information is then passed by the state manager 33 to the registration system 34, which stores the user registration information to the store 36.

In one embodiment, the registration system 34 determines whether all required registration information has been provided, and if not, alerts the user through the user device 31 and/or requests any further required registration information. This is one example situation in which translation from a management system data format or protocol to a user channel data format or protocol by the translator 32 is desirable. During any subsequent exchanges between the management system 30 and the user device 31 to complete user registration, the state manager 33 preferably maintains a session state.

The registration system 34 may also perform other checks on registration information, to validate the information provided by a user, for example. The validation process may involve accessing the user information store 36 to detect duplicate user information in the user information store 36. This may occur, for example, where a user that has already registered with the management system 30 attempts to re-register. User registration information for a currently registering user may also be identical, in whole or in part, to that of a different user. In both these cases, the registration system 34 preferably alerts the user during the registration process.

The user may also be given an opportunity to resolve any conflict between user registration information, for instance by providing further information. As an illustrative example, consider two users having the same name and the same business telephone number, one of which has registered with the management system 30 using only a name and a business telephone number. If the second user then attempts to register with the management system 30 using the same name and business telephone number, the registration system 34 detects the first user's registration information as a duplicate, and alerts the second user. The second user may then abort the registration process, or resolve the registration information conflict by providing further information, such as a middle initial, an address, or a home telephone number to distinguish the second user from the first user in the user information store 36.

In some embodiments, differentiation of user registration information or accounts is based on user password. When user registration information which is provided by a new user is found in the user information store 36 by the registration system 34, different user records including the same information may be maintained in the user information store 36, provided the new user supplies a different password than the existing user. If the management system identifies user accounts on the basis of home telephone number, for example, this type of password differentiation would allow different users in the same household to register with the management system 30.

The above user registration schemes provide for the association of common information with multiple users or accounts. The extent to which user information may be allowed to overlap or the particular types of user information which need not be unique may be configurable by an owner or operator of the management system 30. Whereas the same business or home telephone number may be used by multiple users and thus appear in multiple records in the user information store 36, mobile telephones tend to be associated with only a single user. An owner or operator of the management system 30 may therefore establish a validation operation to deny user registration or perform error processing if a user provides a mobile telephone number which already appears in the user information store 36 or attempts to register using a mobile telephone which has been previously registered.

Other possible alternative or additional validation operations include checking any entered email addresses for one and only one “@” symbol, checking mailing addresses for a proper postal code, zip code, or other code used in mailing addresses, confirming, illustratively by reverse lookup, that any telephone numbers provided by a user are associated with addresses which are also provided by the user, and ensuring that user preferences are consistent with registration information, for example by verifying that a valid mailing address has been provided when a user selects mail as a delivery preference. Validation may also include verifying that all required registration information, illustratively at least one electronic address and a physical address, have been provided by a user.

The above examples of validation operations are intended solely for illustrative purposes. Other user or registration information validation operations may also be performed, instead of or in combination with those described above.

Whereas certain types of user registration information may be required for registration of a user with the management system 30, other types of optional information may enhance the set of features of the management system 30 that a user can access. For example, although the management system 30 might require only a name and an email address for registration, delivery options for a user are limited to email unless the user also provides further address information such as a mailing address. In one embodiment, the registration system 34 prompts the user for such optional information, at registration or at a later time. The registration system 34 may also or instead be configured to update the user information store 36 whenever a registered user provides further information, whether or not in response to a prompt. Often, a user becomes comfortable providing personal information to an external entity such as an operator of the management system 30 after an initial service period. It is therefore contemplated that the services which are available to a user from the management system 30 could be expanded as the user provides additional user information.

The types and formats of data stored in the user information store 36 are dependent upon a user administration scheme to be employed in the management system 30. In embodiments in which each user is uniquely associated with particular communication devices and/or user channels, the management system 30 may identify users based on a communication device or user channel. For example, where the user provides a wireless communication device identifier and an email address to the management system 30, subsequent communications from that wireless communication device or email address are associated with the user. In some instances, such identification information can be automatically determined by the management system 30 during communication with the user. The determination of telephone numbers, mobile communication device identifiers, and Internet Protocol (IP) addresses or other identifiers associated with personal computers, for example, are known.

This user administration scheme is feasible when a communication device is used by only one user for accessing the management system 30, and each user uses only his or her own communication devices to communicate with the management system 30. However, creation of unique user accounts for each user at the management system 30 effectively removes any communication device-related restrictions on user access. In a user account embodiment, when the user registers with the management system 30, the registration system 34 creates a user account and assigns a user name and a password. As will be apparent, the user name and password may be selected by the registration system 34 or submitted by the user during registration. The user then loge in to the user account to access the management system 30.

In a preferred embodiment, a combination of these user administration schemes is implemented. A user account is created for each user at registration, but a login is required only in certain circumstances, such as where a communication device from which the management system 30 is being accessed is associated with more than one user account or is not recognized by the management system 30. For example, a mobile telephone tends to be user-specific, whereas multiple users often share computer systems. In this case, each user may have an account with the management system 30 associated with both the computer system and a respective mobile telephone. When the users access the management system 30 using their mobile telephones, the management system 30 distinguishes between user accounts based on a mobile telephone identifier stored in the store 36 for each user account. Communications from the computer system cannot be distinguished in this manner. In the latter case, user identification and authentication may instead be based on a password or other information provided by a user when attempting to access the management system 30.

According to another embodiment, a registered user is always given an option of logging in to a user account, with a default action of device-based account access as described above when the management system 30 is able to determine one associated user account from a communication device identifier. For enhanced security, login to a user account may be required for any access to the management system 30. It is also contemplated that login policy settings for each user account, communication device, or user channel may be configured by the user, by the management system 30, or both.

The administration interface 28 and the offer system 40 effectively provide a configuration system or function for the marketer. Through the administration interface 28, the marketer configures offers in the management system 30 to make its marketing campaign materials available to registered and possibly non-registered users of the management system 30.

Depending upon the particular marketer and offer administration scheme employed at the management system 30, registration of an offer may require that the marketer establish at least a master account with the management system 30 if one has not already been established. Offer registration may then proceed either substantially concurrently with or subsequent to the creation of a subordinate account for the offer. The marketer may have a single master account and multiple subordinate accounts associated with respective offers.

During offer registration, offer information is provided to the offer system 40, through the administration interface 28 and the translator 32 or a separate translator where more than one type of administration channel is supported. Offer information preferably includes details relating to the marketing campaign materials being made available by the marketer, such as the type of materials being made available and any offer rules or conditions. Materials from the marketer typically include one or more of free information, free trial product samples, and free trial periods for services, although other types of marketing materials are also contemplated as described above.

Offer rules may be established by the marketer through the administration interface 28 to control various aspects of offer handling. For example, a marketer might establish a limit on the number of information packages or free samples that may be requested by any user. Offer rules also enable the marketer to establish different variations of an offer based on such user information as delivery address parameters, a telephone area code, and/or age or other demographic information. Using offer rules, a single offer may be fulfilled differently for different users based on user information.

The user information which is used in offer rule processing may be accessed in the user information store 36 in the case of a registered user, provided by a user in a request or in response to a prompt from the management system 30, or determined by the management system 30 through a reverse lookup, for example. In some embodiments, offer rules involve information which is not necessarily associated with a user from whom a request is received. For example, a registered user may request that marketing materials be delivered to another person, using a “send to friend” or analogous function. Offer rules may then be applied to a destination address which may have been provided by but is not itself associated with a user.

Offer rules are in no way limited to rules which relate to user information. A marketer may establish limits on the number of requests which may be fulfilled for any particular user or the total number of samples or brochures which are available, for instance.

Offer information which is input by the marketer through the administration interface 28 is stored to the offers store 42. The offer system 40 parses or otherwise reformats marketer information received from the administration interface 28, if necessary, into an offer data format for storage.

Each offer in the offers store 42 preferably includes an offer identifier that will be disseminated to users by the marketer. Offer identifiers may be established by the marketer and provided to the management system 30 with offer information, for example.

As described above, offer rules may be established such that different but related marketing materials are targeted to different user locations, for example. In this case, a user in one mailing address parameter range might receive different marketing materials than a user in another mailing address parameter range. For an offer with such offer rules, several offer storage options are possible. In one embodiment, two separate offers are stored to the offers store 42. In another embodiment, a single offer is stored in the offers store 42 and the request system 44 determines the offer rule, and thus the variation of the offer, that applies to a particular request from a user. Request processing is described in further detail below.

The administration interface 28 and the offer system 40 are preferably configured such that a marketer can access and manage offers in the offers store 42, to modify or delete existing offers or to add new offers. In one embodiment, a separate access account for each offer is created when the offer is configured using the administration interface 28. Account access control through password protection, for example, then enables exclusive control of each offer.

A user of the device 31 may submit requests relating to marketing campaign offers which have been created within the offers store 42 of the management system 30. The marketer disseminates offer identifiers that are stored in the offers store 42 or access codes that are associated with stored offer identifiers. Dissemination may be accomplished through virtually any medium, by adding such offer identifiers or access codes to advertisements, for example.

It should be apparent from the foregoing description of offer identifiers that the marketer may disseminate either offer identifiers that are stored in the offers database 42 or access codes that are associated with such offer identifiers. The present invention is in no way limited to implementations in which a user must acquire offer information that has been stored at the management system 30. An access code which is disseminated by a marketer and included in a user request need not necessarily be stored in the offers store 42 at the management system 30, provided the management system 30 is able to map a user request made via the access code to an offer in the store 42.

When the user wishes to request marketing campaign materials using an offer identifier or access code, the user submits a request to the management system 30. Offer identifiers or access codes are obtained by the user from a billboard, a TV ad, a web page, a radio ad, or some other source. The management system 30 preferably supports multiple types of identifiers or codes that are handled in different ways. According to one possible request scheme, offer identifiers which are stored at the management system are inserted into user requests by the user, whereas in another scheme, access codes which are used in user requests are not themselves stored at the management system 30, but can be translated or otherwise matched with stored offer identifiers.

The translator 32 enables the user to communicate with the management system 30 through a variety of user channels, as described above. User communications may be further enhanced or enabled by one or more clients at the user device 31. Illustrative examples of such a client are described in further detail in the co-pending application [Attorney Docket No. 72750-1059] referenced above.

Although the user may initially register with the management system 30 or submit earlier requests to the management system 30 using one of the user channels, the user is preferably not restricted to only that user channel for subsequent communications with the management system 30. This provides for single-point user registration whereby the user may register for a service only once using one user channel and subsequently use the service through any of multiple user channels supported by the management system 30. Such user channel independence also allows users to access the management system 30 through any available user channel, regardless of the particular user channels which may have been used for previous interactions with the management system 30, whether for user registration, requests, or both.

The operations and user interfaces involved in user request submission are dependent upon the type of communication device or user channel through which the request is to be submitted. In a preferred embodiment, the user is given a choice of available delivery options for requested marketing campaign materials, which may also vary by marketer, offer, or user. Where the user has provided only an email address, for example, then only one delivery option is available. A request submission system or component on a communication device is preferably also configured to prompt a user for login information if login to a user account is required for request processing at the management system 30. If the management system 30 also allows non-registered users to submit requests, then login information would not be required for at least non-registered users.

Access to the management system 30 through any of a plurality of supported user channels may be based on user login, communication device identification, or some combination thereof, for instance. User requests are translated by the translator 32 and passed to the request system 44. The request system 44 may then determine whether a user login is required for processing of the request. If the request system 44 is able to ascertain an identifier of a communication device from which the user request was received, then the login determination is preferably made based on the device identifier. Where the device identifier is associated with more than one user account, then the request system prompts the user for login information such as a user name and password. Login may also be required for certain types of devices, user channels, or requests, and for any user accounts that have been configured for login-only access. Therefore, the determination as to whether a login is required is based on one or more of the communication device or user channel over which a user request is received, information in the user request, or information in the user information store 36. For a relatively high level of security of the management system 30, the request system 44 always requires login to a user account.

Login information, if required, is either provided in the user request or subsequently requested from the user 31 by the request system 44 through the translator 32.

Account login represents one type of access control mechanism. Other types of access control, such as user authentication through a different user prompt and response scheme for instance, may be used instead of or in combination with the access control mechanisms described above to provide a desired level of security.

In order to accommodate non-registered users, the request system 44 may be configured to process requests without a login or authentication operation. However, it may be desirable to provide some level of security or access control for non-registered users. One possible access control mechanism which may be applied to non-registered users is blocking access for particular users, devices, or user channels. In wireless communication networks, this concept is also known as “blacklisting”. This type of access control might be used to protect the management system 30 from denial-of-service attacks originating with particular users, communication devices, or user channels, for instance. Blacklisting may also be based on other user information, for both registered users and non-registered users. A registered user's account might be blacklisted, for example, if the user fails to abide by the conditions of an account agreement.

It is also contemplated that different access control mechanisms may be implemented for different user channels. Some access channels may require login to a user account and thus be restricted to registered users, whereas other user channels may support access by non-registered users through another access control mechanism.

When the user has successfully logged in to a user account or satisfied other access controls, if any, the request system 44 determines a delivery mechanism for fulfilling the request. A preferred delivery mechanism may be specified in the request or in user information in the store 36 for a registered user. If the user has specified a delivery mechanism in the request for which corresponding information has not been provided to the management system 30, then the request system 44 may alert the user and preferably prompts the user to either select an alternate delivery mechanism or provide required information for the specified delivery mechanism.

The request system 44 also determines to which offer in the store 42 the received request relates. As described above, either an offer identifier or access code is included in a request. In a basic implementation, the request system 44 extracts an offer identifier from the request, matches the identifier with an offer identifier stored in the offers store 42, and retrieves information on a particular offer from the store 42.

A somewhat more flexible approach to request processing involves mapping access codes that are disseminated by the marketer with offer identifiers that are stored in the offers store 42. This enables “local” administration of offer identifiers used in the store 42 by the marketer. In such an implementation, offers and identifiers in the store 42 can be modified and re-mapped as required without affecting access codes that have already been disseminated.

The request system 44 further processes the user request if the offer in the store 42 to which the request relates includes offer rules. The user request is denied, for example, if the user has already made a maximum number of requests relating to the offer. A single offer may also have different variations dependent upon demographic, address, or other user information provided by the user in the request or during request processing and/or user information stored in the user information store 42. Thus, request processing by the request system 44 may involve information that was provided in or subsequent to the request, information that was provided prior to the request in the case of a registered user, or both.

After an offer or a particular variation of an offer has been selected, the request system 44 preferably performs compatibility checks between the request and the offer. For example, the user may have specified delivery to a mailing address in the request, whereas the marketer may have made the offer available only for electronic delivery. The user preferably has a choice of delivery mechanisms where the marketer supports multiple delivery mechanisms for the offer and user information for more than one of the supported delivery mechanisms is stored at the management system 30. It is also possible that a user might not satisfy one or more offer rules. The request system 44 preferably alerts the user to any such incompatibilities. If it is possible to resolve a request/offer issue by modifying the request, then the user is preferably prompted appropriately, to select an alternate delivery mechanism or provide further information, for instance. Otherwise, the alert may be in the form of an error or failure message.

When an original or modified request has been matched to a compatible corresponding offer, the request system generates a unique order for the request. The order includes information relating to the offer, the delivery mechanism, and any addressing information required for the delivery mechanism. Orders are stored in the orders store 46 by the request system 44.

The order manager 47 retrieves orders from the orders store 46 and forwards the orders to the fulfillment system 52. In one embodiment, the order manager 47 is implemented using an Enterprise Resource Planning (ERP) tool such as SAP™. It should be appreciated, however, that the particular tool used to implement the order manager 47 may depend upon a desired level of functionality or the capabilities to be supported for order management. Basic order management functions may be provided by tools, including custom tools developed by or for an owner or operator of the management system 30, which are much less extensive than a typical ERP tool.

When an order is sent to the fulfillment system 52, its status in the orders store 46 is preferably updated to “in process” or the like by the orders manager 47. This status update may be dependent upon an acknowledgement of receipt of the order from the fulfillment system 52. The order manager 47 also moves an order from the orders store 46 to the filled orders store 48 at some point after the order has been sent to the fulfillment system 52. In a preferred embodiment, an order is considered to be filled when the fulfillment system 52 acknowledges that order fulfillment has been completed. Instead of moving an order between different data stores or creating filled order records in a separate filled order store 48, the order manager 47 may further update the status of an order in the orders store 46 to “fulfilled”, for instance, to provide for an implementation in which a single orders store is used.

The fulfillment system 52 preferably includes subsystems or components associated with a plurality of delivery mechanisms. Each delivery mechanism may be associated with a corresponding delivery service provider, although a delivery service provider may support multiple delivery mechanisms. The fulfillment system 52 determines to which delivery service provider an order should be routed based on an indication, in the order, of the delivery mechanism to be used to fill the order. The fulfillment system 52 preferably supports at least electronic delivery mechanisms, such as SMS and email, and physical delivery mechanisms such as regular post and courier. Electronic fulfillment via SMS or email may be desirable for providing electronic coupons to mobile communication devices, for instance, whereas physical fulfillment would be suitable for delivery of printed materials, samples, or purchased goods.

It is also contemplated that a preferred delivery service provider may also be specified by the marketer, in the offers store 42 for instance, and included in the order sent to the fulfillment system 52. The fulfillment system 52 then selects the particular delivery service provider for fulfillment of the order. In some embodiments, the marketer fulfills orders which relate to particular ones or possibly all of its own offers.

As will be apparent, user information is provided to the fulfillment system 52 by the management system 30 to enable delivery of requested marketing materials to the user. Therefore, the fulfillment system 52 and every delivery service provider affiliated with the fulfillment system 52 is preferably bound by obligations to maintain confidentiality of the user information and not to use the user information for any purposes other than fulfillment of the particular order. These types of obligations are common in contracts or other agreements.

For effective order management and tracking, the fulfillment system 52 preferably provides an acknowledgement to the order manager 47. For example, the fulfillment system 52 may acknowledge that an order has been received, that an order has been forwarded to an appropriate delivery service provider, that the delivery service provider has sent requested marketing campaign materials to the user, and/or that the delivery service provider has confirmed delivery of the marketing campaign materials to the user.

Although the management system 30 and the fulfillment system 52 are shown as separate blocks in FIG. 2, the management system 30 may include delivery systems or components. For example, files, software, and other electronic materials corresponding to offers for which delivery via email is available are preferably stored at the management system 30 in the offers store 30 or a separate store. The order manager 47 then forwards orders for locally stored materials to a delivery system or component in the management system 30 for fulfillment.

When the order manager 47 determines that an order has been fulfilled by the fulfillment system 52, it transfers the order from the orders store 46 to the filled orders store 48, such as by moving or copying order information from the orders store 46 to the filled orders store 48. The reporting system 50 is configured to compile records of filled orders for various stakeholders in the management system 30. For example, the user may wish to view records of past requests, to review processing times for particular requests or to determine whether a recent request has been processed.

The reporting system 50 is perhaps of most value to the marketer. As described above, each order identifies at least the marketing campaign materials requested by a user, a delivery mechanism, and user information for the delivery mechanism. From this information alone, the marketer can track how many requests have been made for particular offers, statistics on how the offers have been fulfilled, and possibly information about the users that have submitted requests for the offers.

In the management system 30, the reporting system 50 is connected only to the filled orders store 48. According to another aspect of the invention, the reporting system 50 is also connected to one or more of the other stores 36, 42, and 46. Where the user information store 36 is accessible to the reporting system 50, reports for the user or the management system 30 may include user information that is not in the filled orders store 48, to enable verification of the user information, for instance. Information on currently available offers for the marketer may similarly be provided in marketer reports, or in user reports if the marketer wishes to allow users to query its current offers. Connection of the reporting system 50 to the orders store 46 enables reporting of pending orders in addition to filled orders.

The reporting system 50 may be configured to provide reports according to any of several reporting modes. Billing reports, for example, are preferably generated once per billing period. Other reports may similarly be generated and distributed periodically. In a preferred embodiment, the reporting system 50 is responsive to queries from registered users and marketers. Since the reporting system 50 has access to the filled orders store 48, and possibly the orders store 46, reporting system queries provide the marketer with access to substantially real-time data relating to any current marketing campaigns that have been configured in the management system 30. The marketer is then able to measure the effectiveness of the campaign and modify strategy accordingly. This type of tracking information is rarely, if ever, available in such a timely manner for conventional marketing campaigns.

Campaign tracking is further enhanced by managing offer identifiers or access codes in accordance with another aspect of the invention. Where the marketer seeks to measure the effectiveness of a particular advertising medium, for example, a different offer identifier or access code is established for and disseminated via each medium. Thereafter, the medium from which an offer identifier or access code associated with a received request was obtained by a user can be determined. Virtually any degree of granularity may be established by the marketer.

In one embodiment, multiple identifiers or access codes are established for a particular offer, and the marketer displays the identifiers or access codes on billboards at different locations. Tracking of received requests based on each identifier or access code may be enabled in several ways. The marketer may configure different offers respectively associated with the identifiers in the offer system 40 of the management system 30. Each offer, and thus each identifier or access code, is trackable in reports from the reporting system 50. According to one possible alternative implementation, the multiple codes are mapped to the same offer, but the request system 44 is configured to include in each generated order an indicator of the access code used to submit the request. The reporting system 50 is then preferably configured to report the originating access code in reports for the marketer.

User channel tracking is also contemplated, for example, by configuring the request system 44 to include in each order an indicator of the user channel over which the corresponding user request was received.

Tracking of denied user requests allows the management system 30 to identify any users, whether registered or not, that often submit requests relating to offers more than a maximum number of times or re-submit previously denied requests. These types of user activities may point to attempted denial of service attacks or service abuse, for which the management system 30 may then take such appropriate action as suspending or deleting a user account.

Records of denied or otherwise unfulfilled requests also allow the marketer to detect a pattern of users aborting requests for marketing materials that are not available through a particular delivery mechanism for instance, or the fact that offer rules are disqualifying many users from receiving requested marketing materials related to an offer. Responsive to this type of information, the marketer may modify offers or offer rules or register additional offers using the administration interface 28 in order to reach more users. One implementation that provides for tracking of denied requests includes a denied request store connected to the request system 44 and the reporting system 50. The request system 44 writes information relating to any denied requests to that store and then halts any further processing of such requests.

Requests which are aborted or denied based on user or request validation errors may also be tracked in a substantially similar manner.

A request tracking scheme need not be restricted to only one specific type of tracking mechanism. Different request tracking mechanisms may be used in the same management system 30. Records of denied requests may be kept only for requests which were received through particular user channels, for instance.

Other tracking options will be apparent to those skilled in the art to which the invention pertains.

As described briefly above, the translator 32 enables the management system 30 to communicate with the user device 31 through any of a plurality of user channels. Further details on this input-agnostic aspect of the invention are provided below with reference to FIG. 3, which is a block diagram showing an embodiment of the translator 32.

The example translator 32 of FIG. 3 includes a plurality of interfaces 60, 62, 64, and 66, and a translation engine 68. Multiple user channels supported by the translator 32 are shown between the user 31 and the interfaces 60, 62, 64, and 66. Multiple marketer channels may also be supported by the translator 32 or a substantially similar but separate translator.

Although a limited number of interfaces are shown in FIG. 3, the invention is in no way restricted to those or any other specific interfaces. The Internet interface 60, for example, is but one type of network interface. Furthermore, systems embodying the techniques described herein may include further or fewer components than those shown in FIG. 3. Generally, the translator 32 converts between a user's “plain language” instructions and data and a management system-compatible format, regardless of the nature and type of the plain language. Examples of plain language in this context include voice received through a voice recognition system, digits keyed into a telephone, and text typed into an online form.

The interfaces 60, 62, 64, and 66 comprise appropriate hardware and software components for the respective supported user channels. The segregation of interfaces in FIG. 3 is purely for illustrative purposes, intended to represent different types of user channels. For instance, the Internet interface 60 might include a modem, which actually accesses the Internet through a telephone system, or a WAP gateway that is accessible through a wireless communication network. Similarly, the wireless network interface 62 would in most cases communicate with a wireless communication device through a telephone network and a wireless communication network, not directly through a wireless communication network. However, since communications with the user device 31 over an Internet-based user channel, a wireless network-based user channel, and a telephone-based user channel may be handled somewhat differently, separate interfaces for these user channels have been shown in FIG. 3.

The translation engine 68, preferably implemented primarily in software, converts signals from formats and protocols associated with any of the interfaces 60, 62, 64, and 66 into a format compatible with components of the management system 30. In a preferred embodiment, the translation engine also translates signals from the management system 30 for each interface 60, 62, 64, and 66. For each interface, at least two types of exchange are contemplated—user registration and user requests. Other types of exchange may also be supported, to allow a registered user to provide additional information to be added to a user information store after the user has already registered, for example.

The Internet interface 60 connects the translator 32 to computer systems and devices through the Internet, and preferably supports multiple protocols and data formats. During registration via an Internet user channel, the user accesses a web page associated with the management system, through a computer system or other Internet-enabled device, and completes and submits a registration form. The form is received by the Internet interface 60 and the received form or registration information from the form is passed to the translation engine 68. The translation engine 68 then translates the form or registration information into a management system-compatible format, and registration proceeds as described above. Any subsequent outgoing communication from the management system to the user during registration, such as a request for further registration information, is translated by the translation engine 68 into a format compatible for transfer to the user device 31 via the Internet interface 60. According to a further aspect of the invention, the translation engine 68 translates such subsequent communications into a format for a different interface and user channel. User registration via an Internet-based user channel also preferably involves storage of registration information, as a “cookie” for instance, at the device from which registration was initiated.

Most user requests over an Internet-based user channel will be generated in response to the user clicking on, mousing over, or otherwise selecting a button, management system icon, banner ad, or the like on a web page. In a preferred embodiment, selection of the button, icon, or ad displays a request menu from which the user selects at least a delivery mechanism. Currently available offers may also be displayed for selection. As described above, the user, if registered, may be prompted or given an option to enter login and/or authentication information for a user account. If the user is currently using the same device that was used for registration with the management system, then registration information that was stored at the device during registration is retrieved. Where more than one user has registered with the management system using the same device, then identifiers for all such users are preferably displayed for selection. The entered or selected delivery mechanism, an offer identifier, login and/or authentication information if required, and registration information, are formatted into a request and sent to the internet interface 60. The request is translated by the translation engine 68 and processed as described above.

Examples of an Internet user channel and Internet-based exchanges between a user and a management system have been described in U.S. patent application Ser. No. [Attorney Docket No. 72750-1059], referenced above.

Registration and request operations for the wireless network interface 62 and the telephone network interface 64 are substantially similar to those for the Internet interface 60. Although the data formats, protocols, and translation schemes may vary between the different interfaces, the overall registration and request processing operations are substantially similar across all interfaces and are therefore described only briefly below.

The wireless network interface 62 supports wireless communication links as user channels. A request from a wireless communication device may include, for example, an access code and a mobile telephone number or other identifier of the wireless communication device, which are translated by the wireless network interface 62 into a data format used by the management system.

SMS and MMS are examples of types of user channel which may be supported by the wireless network interface 62. Many wireless communication devices are also enabled for Internet browsing, for which registration and request operations have been described above in conjunction with the Internet interface 60.

The telephone network interface 64 supports such user channels as automated telephone systems, including voice recognition and touch-tone systems for instance, and operator-assisted systems. These user channels are typically accessible through toll free or local telephone numbers. As above, information received by the translator 32 is translated for the management system or the user by the translation engine 68.

The translator 32 is preferably scalable, such that further interfaces, illustratively the interface 66, can be added to support new user channels as they become available. In the translator of FIG. 3, each interface is configured to communicate with the translation engine 68, such as through one or more application programming interfaces (APIs) or translation engine protocols. An example of a potential future user channel is interactive television. Although still in its infancy, it is contemplated that interactive television may be adapted to provide for user registration, requests, or both, by selecting an icon which is displayed during a television show or commercial using a remote control, for example. Other user channels may also be apparent to those skilled in the art or become available in the future. The invention is in no way limited to the particular interfaces shown in FIG. 3.

The translator 32 in FIG. 3 is modular in the sense that each interface 60, 62, 64, and 66 is substantially independent of the other interfaces. Interfaces may be added or removed without affecting other interfaces. However, each interface relies on the same translation engine 68 for data translation. In another embodiment, the translator 32 includes self-contained translation modules that support both interface and translation functions. Such a translation module implementation provides for enhanced isolation between different interfaces and their user channels, whereas a common translation engine may provide for a more compact implementation for multiple interfaces in that software code for translation functions is shared between interfaces, for example.

Many different management system data formats will be apparent to those skilled in the art. Although the translation engine translates multiple user channel formats into extensible Markup Language (XML) in one embodiment of the invention, other formats may instead be used by a management system.

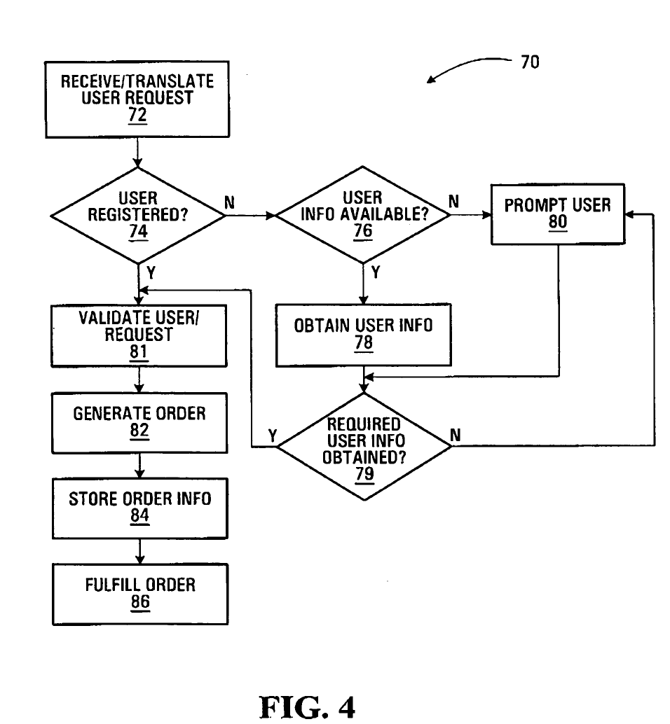

FIG. 4 is a flow diagram showing a method of processing a user request in accordance with an embodiment of the invention. Many of the operations in FIG. 4 will be apparent from the foregoing description. It should be appreciated that embodiments of the invention may include further or fewer operations than those explicitly shown in FIG. 4, which may be performed in a different order.

The method 70 begins at 72, when a user request is received and translated at a management system. At 74, a determination is made as to whether the user from whom the request was received is registered with the management system. If the user is a registered user, then validation operations are performed at 81 to authenticate the user, by prompting for a password or checking a blacklist for instance, to validate the request, by confirming that the request identifies a valid offer and satisfies any offer rules, or both. Following successful validation at 81, an order is generated at 82, information about the order is stored at 84 for subsequent reporting functions for example, and fulfilled at 86. The operations at 84 and 86 are examples of operations which may be performed in either the order shown or in a different order. Whether an order is stored before or after it is sent for fulfillment is a matter of preference.

Although not explicitly shown in FIG. 4 so as to avoid congestion, it should be apparent that a validation failure at 81 preferably invokes some sort of error processing. Request denial and possibly recording, halting of further request processing, returning an error or failure message to a user, referring a user to a different user channel, and reverting to 76 (described below) where the validation failure was a result of missing required information which may be available from the user or another source are all examples of possible error processing.

According to a further aspect of the invention, a user need not necessarily have registered with the management system before submitting a request. As shown at 76, a determination is made as to whether information for an non-registered user is available or accessible from the request itself or from another source which is external to the management system.

For example, the management system may be able to extract a network address, telephone number, equipment identifier, or other identifier from communication signals received over certain user channels, and then determine whether registration information is available from an external service provider. Where the request is received from a wireless communication device for instance, the management system preferably extracts an equipment identifier or telephone number from the request and determines the wireless communications service provider associated with the device. A marketer may have an existing business relationship with the service provider. Such an affiliated service provider preferably provides at least an indication of wireless communication service registration status or account status for a user in response to a query from the management system.

A reverse lookup function or service represents another possible source of user information, whereby other user information, often including name and mailing address information, may be obtained based on a telephone number.

Therefore, operations at 76 may involve communications between the management system and an external entity, such as a communication service provider, or a local determination, of whether a reverse lookup function is available for instance. It should be appreciated that the above techniques for obtaining user information may be applied in processing service requests associated with other types of system than a marketing communication management system.

If user information is not available, then the user is preferably prompted for additional information at 80. Where user information is available to the management system, such as from an external service provider or reverse lookup, then the available information is obtained at 78.

In some embodiments, user permission may be required before external sources are consulted at 78. For example, the user may be prompted, such as by using a dialog box or menu prompt on a communication device for example, for permission to port user information from an external service provider to the management system or to perform a reverse lookup. Permission to access user information from other sources may instead be part of a usage agreement or similar arrangement which must be accepted by a user during registration or before or during request processing for non-registered users.

Following an attempt to obtain user information at 78 or 80, the method continues at 79 to determine whether all information which is required to process the request has been obtained. If so, then request processing proceeds at 81 substantially as described above. It will be apparent from the foregoing that operations at 79, such as verifying whether all required information has been provided or obtained, may overlap validation operations at 81. Thus, although shown in FIG. 4 as separate operations, the determination at 79 may actually be implemented as part of a validation scheme, or vice-versa.

In the event that all required information has not been obtained, as determined at 79, the user may be prompted, or prompted again, for further information at 80. The method may instead revert back to 76 in this situation, to determine whether missing information may be available from other sources. A user is preferably given only a predetermined number of attempts or a predetermined period of time to provide all of the information required for processing a request. This prevents a request from remaining active indefinitely. After the predetermined number of attempts have been made without success or the predetermined period of time has elapsed, then the user may be referred to customer support, or some other error processing procedure may be invoked.

The operations at 76-80 allow non-registered users to submit requests to a management system. The porting of user information from an external service provider, which is one option described above, may also substantially simplifies user registration. During a user's registration for a first service with a first service provider, namely the management system, such a porting function allows the same user's registration for a second service with a second service provider to be exploited. User registration with the management system may then be performed automatically, or as simple as a single selection or other response to a prompt for permission, where all required registration information is available from the external service provider.

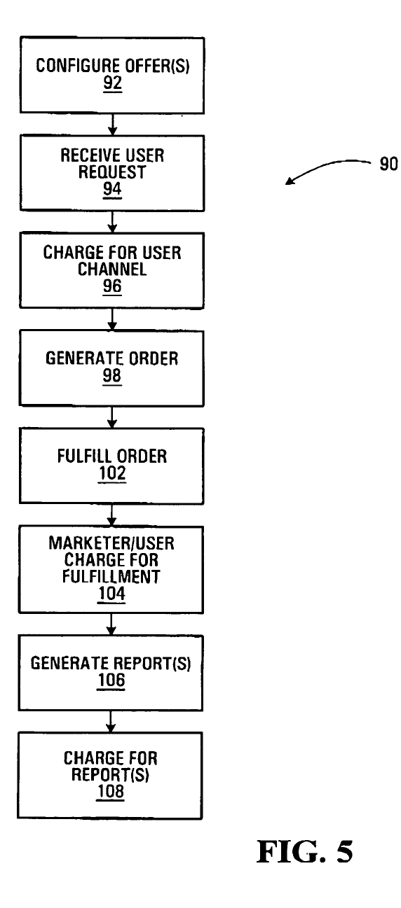

The owner or operator of a marketing campaign management system provides a service to consumer users in that a consumer, as a user of a management system, has more control over marketing materials which they receive. Any of a plurality of different business methods and models are applicable to such systems. FIG. 5 is a flow chart of an example business method according to an aspect of the invention.

In the method 90, a marketer configures one or more campaigns or offers with the management system at 92 as described above. At 94, a user request is received from a user. An initial revenue associated with the user channel through which the user request was submitted may be generated and billed to the user at 96. For example, a wireless communication service provider may bill the user for airtime charges, service charges for premium-based services such as SMS, or both. In some embodiments, the marketer is billed for certain user channel-related charges. Another example of a potential user billing scheme involves the user pre-purchasing a specific number of management system requests or a subscription with the management system. Billing may also be handled differently for different offers. It should be appreciated that not all user channels are expected to have associated charges. Users do not typically incur costs for such user channels as toll free or local telephone numbers and Internet-based user channels unless a wireless communication device is used.

An order for a valid request is generated at 98. When the order has been fulfilled at 102, the marketer, the user, or both, are charged for fulfillment at 104. Fulfillment charges may include charges for materials, such as where the user request is a request to purchase materials or the marketer purchases materials from a third party, delivery charges, or both.

Report generation as shown at 106 may include the generation of reports for users, the marketer, or both. Costs for such reports, if any, are assessed to the user at 108. Users could be charged, for example, for monthly statements or on-demand reports of user activity. As the management system is operated directly by a marketer, it is unlikely that costs would be assessed for marketer reports.

It will be apparent that different entities may handle the charging or billing operations at 96, 104, and 106. User channel billing at 96 is preferably managed by a provider of a communication service through which the user request was submitted. As the management system preferably has order tracking and reporting capabilities as described above, the management system may be responsible for billing of fulfillment charges at 104 and report charges at 108.

Those skilled in the art will appreciate that other business methods are also applicable to the present invention. Methods including fewer, further, or different steps than those explicitly shown in FIG. 5 may be implemented without departing from the invention.

Systems and methods of managing marketing campaigns in accordance with embodiments of the present invention provide marketers with such benefits as greater integration of advertising across multiple media, significantly enhanced advertising effectiveness, and stronger one-to-one relationships with their customers. For consumers, these systems and methods provide a convenient, easy, secure and more controllable means of getting product and service information they require, when they need it.

What has been described is merely illustrative of the application of the principles of the invention. Other arrangements and methods can be implemented by those skilled in the art without departing from the spirit and scope of the present invention.

For example, although not described in detail above, any of a plurality of security mechanisms may be implemented to protect a management system, information stored by a management system, and any transactions between management systems, a marketer, and consumers. Applicable security mechanisms include virtual private networks with third parties to limit service exposure, user authentication through directory services, secure document transmission, access protection such as through firewall rules, data encryption, denial of service attack protection through image recognition, and fraud protection through reply-mail activation, for example. These and/or other security mechanisms may be used to provide a desired level of protection.

In addition, fulfillment has been described above primarily in the context of sending marketing campaign materials to a user, it should be appreciated that fulfillment may also involve such other operations as registering a user for a contest, recording a user's vote in a poll, or purchasing a product. Clearly, many different types of marketing materials and communications are contemplated. In the case of a contest, vote, or product purchase, one marketing material or communication which may be provided to a user is a report of the status or result of fulfillment operations, i.e., confirmation that a contest entry has been received, that a vote has been recorded, or a purchased product has been shipped.

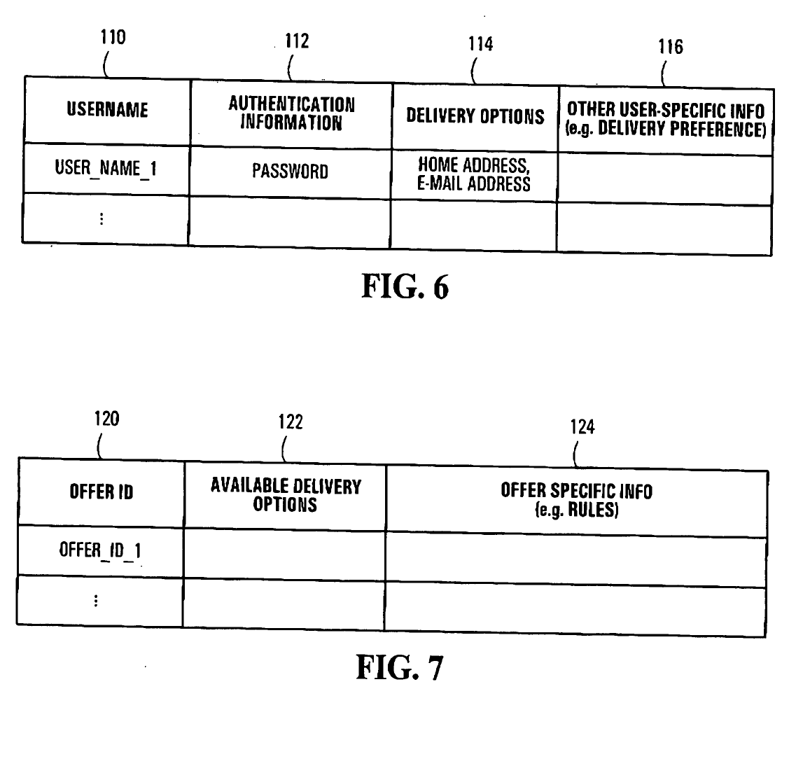

Many different data storage formats or structures may also be used in the various stores shown in FIG. 3. Illustrative examples of these data structures are shown in FIGS. 6 and 7 for user information and offer information, respectively.

FIG. 6 is an example of a data structure that might be used for the user information store 36. Shown is a table having a column 110 for a user name, a column 112 for authentication information, a column 114 for delivery options, including address information provided by a user, and a column 116 for any other user-specific information, for example delivery preference. This type of information may be maintained in any suitable form accessible and usable by the management system, such as in a database. While a specific structure has been shown, more generally any customer information store that allows an association between users and delivery options and the details of these delivery options is contemplated. In the example records shown in FIG. 6, there is a user having user_name_1, which is illustrative of an identifier which may be used to uniquely identify a user. The authentication information 112 consists of a password in FIG. 6, although a challenge question or other authentication information may also or instead be stored for a user. The delivery options 114 consist of the details of a home address and an e-mail address, i.e. an actual home address and any e-mail address. As described in detail above, authentication information may be stored in a separate store with a user's personal information instead of with non-personal fulfillment information such as address information. Thus, it should be clear that the data structure of FIG. 6 is intended solely for the purposes of illustration.

Referring now to FIG. 7, an example of how information might be stored in the offers store 42 is shown. The data structure in FIG. 7 includes is a column 120 for an offer identifier, a column 122 for a list of available delivery options, and a column 124 for any other offer specific information such as offer rules, effective dates of a marketing campaign or the particular offer, etc.

Those skilled in the art will also appreciate that the orders and filled orders stores 46 and 48 of FIG. 3 may have a similar data structure, with various fields including user information, offer information, and delivery information.

It should also be appreciated that even though embodiments of the invention have been described above primarily in the context of systems and methods, other implementations are also possible. The operations disclosed herein may be implemented as instructions stored on a machine-readable medium, for example. In a similar manner, any of the various components shown in FIGS. 1-3 may be implemented using a microprocessor, Application Specific Integrated Circuit (ASIC) or other type of processor which is configurable by software to perform the respective operations of these components.

1. A method of managing a marketing campaign, comprising:
configuring a marketing campaign management system to store an offer of marketing materials to be made available through the marketing campaign management system;
receiving, at the marketing campaign management system, a request from a user relating to the offer;
processing the request based on at least the offer and user information for the user stored at the marketing campaign management system; and
generating an order comprising at least a portion of the user information and offer information associated with the offer to which the request relates.

2. The method of claim 1, further comprising:
receiving a further request relating to the offer from a user for which user information has not been stored at the marketing campaign management system; and
processing the further request based on the offer and at least one of information in the further request and additional user information subsequently received from the user.

3. The method of claim 2, further comprising:
prompting the user to provide the additional user information.

4. The method of claim 1, wherein configuring comprises using an offer configuration function, the method further comprising:
providing an access control mechanism for controlling access to the offer configuration function.

5. The method of claim 4, wherein the access control mechanism comprises a password-based access control mechanism, a challenge-based access control mechanism, or a combined password- and challenge-based access control mechanism.

6. The method of claim 1, wherein configuring comprises modifying an existing stored offer.

7. The method of claim 1, wherein configuring comprises configuring the marketing campaign management system to store a plurality of offers.

8. The method of claim 7, wherein processing comprises determining to which one of the plurality of offers the request relates.

9. The method of claim 1, wherein processing comprises matching an access code in the received request with the offer.

10. The method of claim 9, wherein configuring comprises configuring a plurality of access codes associated with the offer, and wherein matching comprises determining whether an access code in the request comprises one of the plurality of access codes.

11. The method of claim 10, wherein the plurality of access codes comprise at least one of: access codes associated with respective user communication channels through which the marketing campaign management system is adapted to receive user requests, and access codes which have been disseminated through respective advertising media.

12. The method of claim 1, wherein processing comprises identifying the user and locating the user information in a user information store at the marketing campaign management system.

13. The method of claim 1, further comprising:
fulfilling the order.

14. The method of claim 13, wherein fulfilling the order comprises sending the marketing materials to the user.

15. The method of claim 14, further comprising:
storing a record of the order in a filled orders store subsequent to fulfilling the order.

16. The method of claim 1, further comprising:
translating information in the request into a marketing campaign management system format.

17. The method of claim 1, wherein configuring comprises further configuring the marketing campaign management system to store an offer rule for the offer, wherein processing comprises determining whether the request satisfies the offer rule, and wherein generating comprises generating the order where the request satisfies the offer rule.

18. The method of claim 17, wherein the offer rule comprises a condition associated with at least one of the user information stored at the marketing campaign management system and information in the request.

19. The method of claim 1, wherein:
configuring comprises further configuring the marketing campaign management system to store a plurality of offer rules for the offer, each of the plurality of offer rules being associated with a respective variation of the offer;
processing comprises determining which one of the plurality of offer rules is satisfied by the request; and
wherein generating comprises generating an order for the variation of the offer associated with the one of the plurality of offer rules.

20. The method of claim 1, further comprising:
generating a report comprising information associated with at least one of the offer, the request, the user, and a result of processing of the request.

21. A machine-readable medium storing instructions which when executed by a processor perform the method of claim 1.

22. A marketing campaign management system comprising:
an offers store for storing offer information associated with offers corresponding to respective marketing materials available through the management system;
a user information store configured to store user information corresponding to users of the management system;
an administration interface for providing access to the offers store to configure offers in the offers store; and
a request system adapted to receive from a user a request relating to any one of the offers, to process the request based on at least offer information associated with the one of the offers and user information for the user, and to generate an order comprising at least a portion of the user information and the offer information for the one of the offers.

23. The system of claim 22, wherein at least one of the administration interface and the request system is implemented in a processor.

24. The system of claim 22, further comprising:
an offer system coupled to the administration interface and the offers store for receiving inputs of offer information from the administration interface and for populating the offers store with the input offer information.

25. The system of claim 22, wherein the request system is further configured to receive a further request relating to any one of the offers from a user for which user information has not been stored in the user information store, and to process the further request based on offer information associated with the one of the offers to which the further request relates and at least one of information in the further request and additional information subsequently received from the user.

26. The system of claim 22, further comprising:
a user registration system coupled to the user information store for collecting the user information and populating the user information store.

27. The system of claim 22, wherein the request system is configured to process the request by determining the one of the offers to which the request relates.

28. The system of claim 22, wherein the request system processes the request by matching an access code in the request with the one of the offers.

29. The system of claim 28, wherein the one of the offers is associated with a plurality of access codes, and wherein matching comprises determining whether an access code in the request comprises one of the plurality of access codes.

30. The system of claim 29, wherein the plurality of access codes comprise at least one of: access codes associated with respective user communication channels through which the request system is adapted to receive user requests, and access codes which have been disseminated through respective advertising media.

31. The system of claim 22, wherein the request system is further configured to identify the user and to locate user information for the user in the user information store.

32. The system of claim 22, further comprising:
an orders store for Storing order information,
wherein the request system generates the order by storing information associated with the order in the orders store.

33. The system of claim 32, further comprising:
an order manager configured to access the order in the orders store, and to manage fulfillment of the order.

34. The system of claim 33, wherein the order manager manages fulfillment of the order by performing an operation selected from the group consisting of: sending the marketing materials to the user and sending the order to a fulfillment system for fulfillment.

35. The system of claim 33, further comprising;
a filled orders store,
wherein the order manager is further configured to store the order in the filled orders store when the order has been fulfilled.

36. The system of claim 22, further comprising:
a translator configured to translate information entered using the administration interface into a marketing campaign management system format.

37. The system of claim 22, further comprising:
a translator configured to translate information in the request into a marketing campaign management system format.

38. The system of claim 37, wherein the translator comprises a plurality of communication channel interfaces and a translation engine coupled to each of the plurality of communication channel interfaces.

39. The system of claim 38, wherein the translation engine is implemented in computer software and comprises an application programming interface (API) for communication with the plurality of communication channel interfaces.

40. The system of claim 22, wherein the offer information associated with each of at least one of the offers comprises a respective offer rule for the offer, and wherein the request system is configured to determine whether the offer information associated with the one of the offers comprises an offer rule, to determine whether the request satisfies the offer rule where the offer information associated with the one of the offers comprises an offer rule, and to generate the order where the request satisfies the offer rule.

41. The system of claim 40, wherein the respective offer rules comprise a respective condition associated with at least one of the user information stored in the user information store and information in the request.

42. The system of claim 22, wherein:
the offer information associated with each of at least one of the offers comprises a respective set of offer rules the offer, each offer rule in the set of offer rules for an offer being associated with a respective variation of the offer; and
the request system is configured to determine whether the offer information associated with the one of the offers comprises a set of offer rules, to determine which offer rule in the set of offer rules is satisfied by the request where the offer information associated with the one of the offers comprises a set of offer rules, and to generate an order for the variation of the offer associated with the offer rule satisfied by the request.

43. The system of claim 21, further comprising:
a reporting system configured to generate a report comprising information associated with at least one of the request, the one of the offers, the user, and a result of processing of the request by the request system.

44. A method of processing a service request associated with a service provided by a first service provider system, comprising:
receiving, at the first service provider system, a service request from a user, the service request being associated with the service;
determining whether user information for the user is available to the first service provider system from a source external to the first service provider system;
obtaining the user information from the external source where user information for the user is available to the first service provider system from a source external to the first service provider system; and
processing the service request based on at least a portion of the user information obtained from the external source.

45. The method of claim 44, wherein the external source comprises at least one of: a second service provider system with which the user has registered for a second service and a system providing a reverse lookup function.

46. The method of claim 44, wherein the external source comprises a second service provider system associated with a provider of a communication service for the user, and wherein receiving comprises receiving the service request via a communication channel supported by the second service provider system.

47. The method of claim 44, further comprising:
prompting the user for the user information where the user information relating to the user is not available to the first service provider system from a source external to the first service provider system.

48. The method of claim 44, wherein the service request comprises a user registration request to register the user for the service.

49. A machine-readable medium storing instructions which when executed by a processor perform the method of claim 44.

50. A method of managing access codes associated with a marketing campaign management system, the system storing in an offers store offers associated with at least one marketing campaign and processing user requests relating to the offers, the method comprising:
configuring the offers store to store a plurality of access codes for one of the stored offers;
receiving, at the marketing campaign management system, a request from a user, the request including any one of the plurality of access codes;
processing the request to match the request with the one of the stored offers based on the one of the plurality of access codes; and
storing request processing information comprising information associated with the one of the offers and information associated with the one of the plurality of access codes.

51. The method of claim 50, wherein receiving comprises receiving the user request via any of a plurality of user communication channels, and wherein each of the plurality of access codes is associated with a respective one of the plurality of user communication channels.

52. The method of claim 50, further comprising:
disseminating the access codes through a plurality of advertising media,
wherein each of the plurality of access codes is associated with a respective one of the plurality of advertising media.

53. The method of claim 50, further comprising:
generating a report comprising at least a portion of the stored request information.

54. A machine-readable medium storing instructions which when executed by a processor perform the method of claim 50.
